(19) United States
(12) Patent Application Publication
(10) Pub. No.: US 2019/0340216 A1
(43) Pub. Date: Nov. 7, 2019

(54) INTEGRATION SYSTEM BETWEEN A CUSTOMER RELATIONSHIP MANAGEMENT PLATFORM AND AN APPLICATION LIFECYCLE MANAGEMENT PLATFORM

(71) Applicant: American Express Travel Related Services Company, Inc., New York, NY (US)

(72) Inventors: APURVA DUTTA, Phoenix, AZ (US); SHRAWAN RAINA, Phoenix, AZ (US)

(73) Assignee: American Express Travel Related Services Company, Inc., New York, NY (US)

(21) Appl. No.: 15/970,345

(22) Filed: May 3, 2018

(51) Int. Cl. G06F 17/21; G06F 17/30

(52) U.S. Cl. CPC G06F 17/211; G06F 17/30905; G06F 17/30569; G06F 17/3061

(57) ABSTRACT

Systems and methods for integrating communications between a customer relationship management (CRM) platform and an application lifecycle management (ALM) platform are disclosed. The system may retrieve CRM support records and data, reformat the CRM support records or updates into a format readable by the ALM platform, and store the reformatted CRM support record or updates in the ALM platform. The system may retrieve ALM development requests, discussions, and attachments; reformat the ALM development requests, discussions, or attachments into a format readable by the CRM platform; and store the reformatted ALM development requests, discussions, or attachments in the CRM platform.

### FIELD

This disclosure generally relates to customer relationship management (CRM) platforms and application lifecycle management (ALM) platforms, and more specifically, to an integration system to enable communications between CRM and ALM platforms.

### BACKGROUND

Companies may use a customer relationship management (CRM) platform to manage the company's relationships and interactions with customers, potential customers, end users, and similar parties. For example, companies may use the CRM platform to receive user support requests and track customer support interactions. The company support team may review the support requests and support interactions, then create support request entries in an application lifecycle management (ALM) platform. The ALM may use an agile application lifecycle management tool for development or engineering teams to review and fulfill. The support request entries may correspond to servicing requests, enhancements or modifications to the CRM platform. The support request entries may also correspond to other systems or processes, or new project engagements, features, or products.

A technical problem is that the CRM platform and the ALM platform receive and store data in different formats and are not in communication with each other. As a result, manual intervention is typically needed to review the data in the CRM platform and manually enter the data into the ALM platform. In response to completing the ALM platform support request entry, manual intervention is typically needed again to complete the user support request in the CRM platform.

### SUMMARY

Systems, methods, and articles of manufacture (collectively, the “system”) for an integration system between a customer relationship management (CRM) platform and application lifecycle management (ALM) platform is disclosed. The system may retrieve a CRM support record from the CRM platform using a integration controller. The system may reformat, using the integration controller and via an ALM model, the CRM support record into a ALM data format, wherein the CRM support record is reformatted by converting CRM support record data fields into ALM development request data fields based on the ALM data format. The system may transmit, using the integration controller, the reformatted CRM support record to the ALM platform.

In various embodiments, the integration controller may be configured to retrieve the CRM support record in response to being invoked by a CRM query service. The CRM support record may comprise a CRM support record ID and wherein the reformatted CRM support record comprises an ALM development request ID associated with the CRM support record ID. In various embodiments, the integration controller may also retrieve updated CRM data corresponding to the CRM support record ID from the CRM platform; reformat the updated CRM data into a ALM data format, wherein the updated CRM data is reformatted by converting updated CRM data fields into ALM development request data fields based on the ALM data format; and transmit the reformatted updated CRM data to the ALM platform. The ALM platform may be configured to store the reformatted updated CRM data with the reformatted CRM support record based on the ALM development request ID. The integration controller may be configured to retrieve the updated CRM data in response to being invoked by a CRM update service. The CRM platform may be a SALESFORCE™ CRM platform and the ALM platform may be a RALLY™ ALM platform.

In various embodiments, an integration controller in the system may also be configured to retrieve from an ALM platform an ALM development request; reformat using an ALM model the ALM development request into a customer relationship management (CRM) data format, wherein the ALM development request is reformatted by converting ALM development request data fields into CRM support record data fields based on the CRM data format; and transmit to a CRM platform the reformatted ALM development request for storage in the CRM platform.

In various embodiments, the integration controller may be configured to retrieve the ALM development request in response to being invoked by an ALM query service. The ALM development request may comprise an ALM development request ID and wherein the reformatted ALM development request comprise a CRM support record ID associated with the ALM development request ID. The integration controller may also be configured to retrieve from the ALM platform ALM discussion data corresponding to the ALM development request; reformat using the ALM model the ALM discussion data into the CRM data format, wherein the ALM discussion data is reformatted by converting ALM discussion data fields into CRM support record data fields based on the CRM data format; and transmit to the CRM platform the reformatted ALM discussion data for storage in the CRM platform associated with the development request ID of the ALM development request. The integration controller may be configured to retrieve the ALM discussion data in response to being invoked by an ALM discussion service. The integration controller may also be configured to retrieve from the ALM platform an ALM attachment corresponding to the ALM development request; reformat using the ALM model the ALM attachment into a CRM child attachment, wherein the ALM attachment is reformatted by converting ALM attachment data fields into CRM support record data fields based on the CRM data format; and transmit to the CRM platform the CRM child attachment for storage in the CRM platform associated with the development request ID of the ALM development request. The integration controller may be configured to retrieve the ALM attachment in response to being invoked by an ALM attachment service.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating a system for integrating communications between a customer relationship management (CRM) platform and an application lifecycle management (ALM) platform, in accordance with various embodiments;

FIG. 2 is a block diagram illustrating various components of an exemplary CRM to ALM integration system for the system of FIG. 1, in accordance with various embodiments;

FIG. 3 illustrates a process flow for a method of executing a CRM query service in an integration system, in accordance with various embodiments;

FIG. 4 illustrates a process flow for a method of executing a CRM update service in an integration system, in accordance with various embodiments;

FIG. 5 illustrates a process flow for a method of executing an ALM query service in an integration system, in accordance with various embodiments;

FIG. 6 illustrates a process flow for a method of executing an ALM discussion service in an integration system, in accordance with various embodiments; and

FIG. 7 illustrates a process flow for a method of executing an ALM attachment service in an integration system, in accordance with various embodiments.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the system may provide an integration system and/or process to automate communications and data entries between a customer relationship management (CRM) platform and an application lifecycle management (ALM) platform. Users (e.g., business users, support staff, customers, potential customers, etc.) may interact with the CRM platform to create, manage, and/or update CRM support records. The integration system may retrieve the CRM support record, process the CRM support record, reformat the CRM support record into an ALM data format, and transmit the reformatted CRM support record to the ALM platform, as discussed further herein. Users (e.g., support users, development users, engineering users, etc.) may also interact with the ALM platform to create, manage, and/or update ALM development requests. The integration system may retrieve the ALM development request, process the ALM development request, reformat the ALM development request into a CRM data format, and transmit the reformatted ALM development request to the CRM platform, as discussed further herein. In that regard, the integration system may provide a technical solution to the technical problem of needing significant manual intervention and/or input to transfer data between the platforms.

The system further improves the functioning of the computer. For example, by automating the reformatting of support requests between the CRM platform and the ALM platform, as opposed to needing a user to manually reformat and input the data across platforms, the user performs less computer functions and provides less input, which saves on data storage and memory which speeds processing. Additionally, by automating the reformatting and transferring of data between the CRM platform and the ALM platform, the integrity and accuracy of the data may also be increased. In various embodiments, the system further improves resource utilization by syncing changes and updates between the CRM platform and ALM platform in real time, thus also increasing the speed of availability of the information and updates to the users (e.g., development users, engineering users, business users, support staff, customers, potential customers etc.). The system may also eliminate the need for duplicate software licenses for the same set of users using the CRM platform and ALM platform, as the users may work on each individual platform as needed, without the need to manually update the information in the other platform.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data” may include encompassing information such as commands, queries, files, data for storage, information, and the like in digital or any other form.

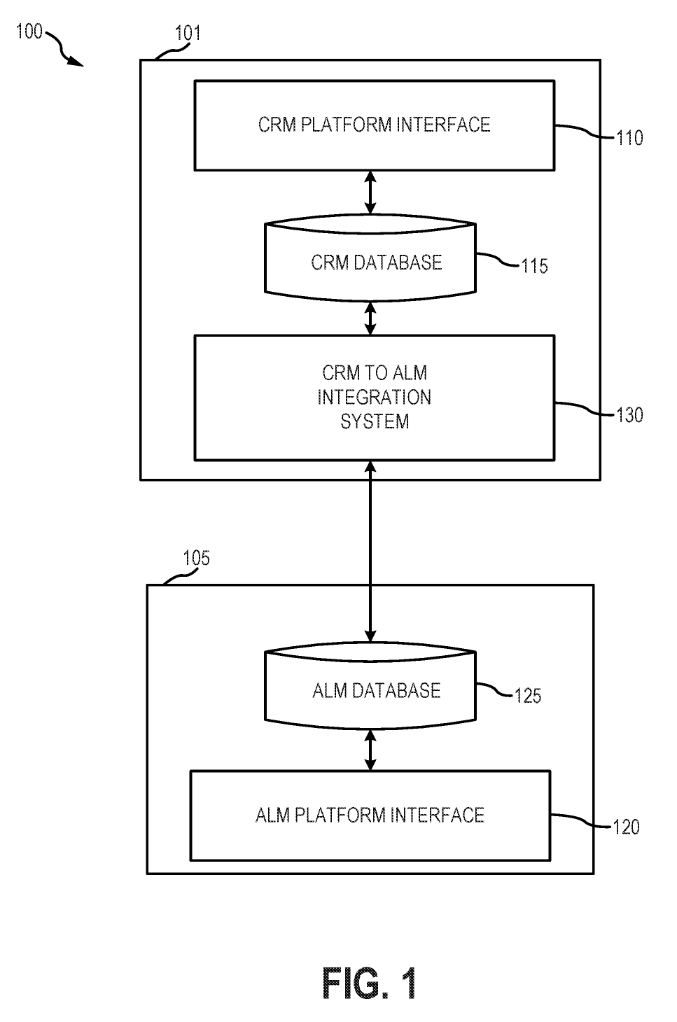

In various embodiments, and with reference to FIG. 1, a system 100 for integrating communications between a customer relationship management (CRM) platform 101 and an application lifecycle management (ALM) platform 105 is disclosed. System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing.

The various systems, platforms, processors, servers, databases, and the like in system 100 may be in direct logical communication with each other via a bus, network, and/or through any other suitable means, or may be individually connected as described further herein. For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system. For example, and in accordance with various embodiments, the individual components of system 100 may be interconnected via a network.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

In various embodiments, CRM platform 101 may comprise any suitable combination of software, hardware, and/or database components. For example, CRM platform 101 may comprise software deployed on an application server, web server, or the like. CRM platform 101 may also be cloud-based and may be stored on an external, remote network available via an internet connection. CRM platform 101 may comprise any suitable type of customer relationship management product, platform, or software. For example, CRM platform 101 may be a SALESFORCE™ CRM platform provided by SALESFORCE.COM™ of San Francisco, Calif. CRM platform 101 may be configured to compile customer data across different channels of interactions, including, for example, telephone, chat, website, social media, and the like. For example, businesses may engage customers via CRM platform 101 throughout the customer lifecycle with the business. As a further example, a user may interact with CRM platform 101 to input a CRM support record. The CRM support record may comprise servicing requests, requests for enhancement or modifications to the CRM platform 101 or internal systems, requests for new additions, features, or products, and/or the like. The CRM support record may comprise unique CRM support record ID. For example, in a SALESFORCE™ CRM platform, the CRM support record may be input into a SALESFORCE CHATTER™ interface.

The data collected by CRM platform 101, including the CRM support records, may be stored in a CRM database 115. CRM database 115 may comprise any suitable database or data structure capable of storing and maintaining the CRM support records. The CRM support records may be formatted and stored in CRM database 115 based on a CRM data format. The CRM data format may specify the data needed for each CRM support record, and may include one or more CRM data fields. For example, and in accordance with various embodiments, CRM data fields may include a “Change Request Title” (e.g., the title of the change being requested); a “Change Request Number” (e.g., the CRM platform support ticket ID or unique ID); a “Request Type” (e.g., the type of change being requested, such as a minor enhancement, a data update, a user support request, etc.); a “Change Owner” (e.g., the user name or ID initiating the change request); a “Requester's Director Email Address” (e.g., the supervisor or leader for the Change Owner); a “Process Name” (e.g., the business process impacted by the change request); a “Change Description” (e.g., a detailed descript of the change request); a “Success Criteria” (e.g., the final desired outcome of the change request); and/or any other suitable or desired data field.

CRM platform 101 may include a CRM platform interface 110 for case management, task management, analytical tools, and/or other services. For example, a user may interact with CRM platform interface 110 to input, access, and view the CRM support records. CRM platform interface 110 may be accessible via a web browser (e.g., GOOGLE CHROME®, MICROSOFT INTERNET EXPLORER®, etc.), a mobile application (e.g., downloaded via APPLE® APP STORE®, GOOGLE PLAY®, etc.), or the like. For example, in a SALESFORCE™ CRM platform, the CRM platform interface 110 may be the SALESFORCE CHATTER™ interface.

In various embodiments, ALM platform 105 may comprise any suitable combination of software, hardware, and/or database components. For example, ALM platform 105 may comprise software deployed on an application server, web server, or the like. In various embodiments, ALM platform 105 may be deployed on the same application server, web server, or the like as CRM platform 101. ALM platform 105 may also be cloud-based and may be stored on an external, remote network available via an internet connection. ALM platform 105 may comprise any suitable type of application lifecycle management tool, product, platform, or software, such as an agile application lifecycle management tool. For example, ALM platform 105 may be a RALLY™ system provided by CA TECHNOLOGIES® of New York, N.Y. ALM platform 105 may provide a central platform to enable software developers, engineers, and similar users to manage phases of a software development lifecycle from beginning requirements through release of the completed software. For example, a user may interact with ALM platform 105 to input an ALM development request. The ALM development request may comprise data describing the software development, such as, for example, a name, a Kanban state, a schedule state, an expected due date, a description, notes, acceptance criteria, and/or the like. The ALM development request may also comprise a unique ALM development request ID. In a RALLY™ ALM platform, the ALM development request may be a RALLY™ User Story or a RALLY™ Discussion.

The data collected by ALM platform 105, including the ALM development request, may be stored in an ALM database 125. ALM database 125 may comprise any suitable database or data structure capable of storing and maintaining the ALM development request. The ALM development request may be formatted and stored in ALM database 125 based on an ALM data format. The ALM data format may specify the data needed for each ALM development request, and may include one or more ALM data fields.

For example, and in accordance with various embodiments, ALM data fields may include a “Change Name” (e.g., the title of the change being requested); a “CRM Case Label” (e.g., a unique ID such as a CRM support ticket ID); a “Custom Field” (e.g., the user's name or ID initiating the request); a “Description” (e.g., a detailed description of the change); an “Acceptance Criteria” (e.g., the final desired outcome of the change); and/or any other suitable or desired data field.

ALM platform 105 may include an ALM platform interface 120. For example, a user may interact with ALM platform interface 120 to input, access, and view the ALM development request. ALM platform interface 120 may be accessible via a web browser (e.g., GOOGLE CHROME®, MICROSOFT INTERNET EXPLORER®, etc.), a mobile application (e.g., downloaded via APPLE® APP STORE®, GOOGLE PLAY®, etc.), or the like. For example, in a RALLY™ ALM platform, ALM platform interface 120 may enable the user to view RALLY™ User Stories or RALLY™ Discussions.

In various embodiments, system 100 may comprise a CRM to ALM integration system 130 configured to enable communications and data sharing between CRM platform 101 and ALM platform 105. Integration system 130 may be in electronic communication with CRM database 115 and ALM database 125. As discussed further herein, integration system 130 may be configured to retrieve data from CRM database 115, reformat the data into an ALM data format, and write the reformatted data into ALM database 125. Integration system 130 may also be configured to retrieve data from ALM database 125, reformat the data into a CRM data format, and write the reformatted data into CRM database 115. Integration system 130 may comprise any suitable combination of software, hardware, and/or database components. For example, integration system 130 may comprise an application programming interface (API), software development kit (SDK), or the like configured to interact with CRM database 115 and ALM database 125 and perform various operations as discussed further herein. In various embodiments, integration system 130 may comprise a component of CRM platform 101. For example, in a SALESFORCE™ CRM platform, integration system 130 may be built with a Rally Rest API configured to allow integration system 130 to interact with a RALLY™ ALM platform.

In various embodiments, integration system 130 may also comprise a standalone system logically separate from CRM platform 101 and ALM platform 105. Integration system 130 may further be in electronic communication with a web browser, application, mobile application, or the like. In that respect, users may interact with the web browser, application, mobile application, or the like to directly view and interact with CRM platform 101 and ALM platform 105, via integration system 130.

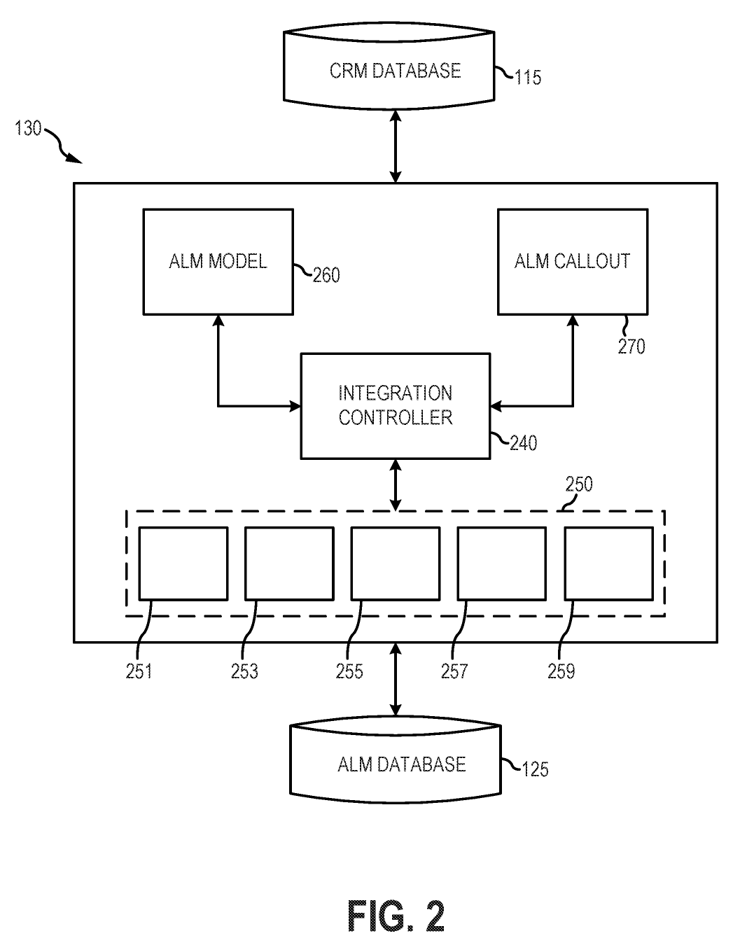

In various embodiments, and with reference to FIG. 2, exemplary architecture of integration system 130 is depicted in greater detail. Integration system 130 may comprise one or more of an integration controller 240, an ALM model 260, and/or an ALM callout 270. Integration system 130 may also comprise one or more integration services 250, as discussed further herein. Integration controller 240 may be configured to perform various operations in integration system 130 in response to being invoked by one or more integration services 250. For example, integration controller 240 may be configured to query CRM database 115 and/or ALM database 125, invoke ALM model 260 to reformat data retrieved from each corresponding database, and invoke ALM callout 270 to transmit the reformatted data to CRM platform 101 and/or ALM platform 105.

Integration services 250 may comprise one or more batch files, services, or the like configured to instruct integration controller 240 to perform various operations, as discussed further herein. Each integration service 250 may be configured to be executed based on an integration event, integration interval, or the like. The integration event may occur in response to a change being detected in CRM database 115 and/or ALM database 125. For example, integration controller 240 may be configured to monitor CRM database 115 and/or ALM database 125, and in response to detecting a change in either database, may invoke one or more integration services based on the type of change (e.g., a new record, an update to a preexisting record, an added discussion or attachment, etc.). The integration interval may comprise any specified time interval, such as, for example, thirty (30) minutes, one (1) hour, four (4) hours, twelve (12) hours, twenty-four (24) hours, etc.

In various embodiments, integration services 250 may comprise a CRM query service 251, a CRM update service 253, an ALM query service 255, an ALM discussion service 257, an ALM attachment service 259, and/or any other suitable or desired number of services. CRM query service 251 may be configured to invoke integration controller 240 in response to CRM database 115 creating and storing a new CRM support record. For example, CRM query service 251 may instruct integration controller 240 to retrieve the new CRM support record, reformat the CRM support record based on the ALM data format, and transmit the reformatted CRM support record to ALM database 125, as discussed further herein. CRM update service 253 may be configured to invoke integration controller 240 in response to CRM database 115 updating a CRM support record. For example, CRM update service 253 may instruct integration controller 240 to retrieve the updated CRM support record, reformat the updated CRM support record based on the ALM data format, and transmit the reformatted updated CRM support record to ALM database 125, as discussed further herein.

ALM query service 255 may be configured to invoke integration controller 240 in response to ALM database 125 creating and storing a new ALM development request. For example, ALM query service 255 may instruct integration controller 240 to retrieve the new ALM development request, reformat the new ALM development request based on the CRM data format, and transmit the reformatted ALM development request to CRM database 115, as discussed further herein. ALM discussion service 257 may be configured to invoke integration controller 240 in response to ALM database 125 updating an ALM development request with additional data, such as discussion data. The discussion data may comprise additional comments, communications (e.g., email, messages, etc.) related to the ALM development request. For example, ALM discussion service 257 may instruct integration controller 240 to retrieve the updated ALM development request (e., the discussion data), reformat the updated ALM development request based on the CRM data format, and transmit the reformatted updated ALM development request to CRM database 115, as discussed further herein. ALM attachment service 259 may be configured to invoke integration controller 240 in response to ALM database 125 updating an ALM development request with additional data, such as an attachment. The attachment may comprise a document (e.g., .doc, .pdf, etc.), image (.jpg., .png, etc.), or the like related to the ALM development request. For example, ALM attachment service 259 may instruct integration controller 240 to retrieve the updated ALM development request (e.g., the attachment), reformat the updated ALM development request based on the CRM data format, and transmit the reformatted updated ALM development request to CRM database 115, as discussed further herein.

In various embodiments, ALM model 260 may be configured to convert CRM data having a CRM data format into data having an ALM data format, and convert ALM data having an ALM data format into data having a CRM data format. For example, the ALM data format may comprise data indicating CRM data fields that correspond to ALM data fields. ALM model 260 may reformat the CRM data by reformatting each of the CRM data fields in the CRM data into one or more ALM data fields, in accordance with the ALM data format. As further example, the CRM data format may comprise data indicating ALM data fields that correspond to CRM data fields. ALM model 260 may reformat the ALM data by reformatting each of the ALM data fields in the ALM data into one or more CRM data fields, in accordance with the CRM data format. As a further example, and in accordance with various embodiments, ALM model 260 may create an object that converts the CRM data into ALM data (and/or the ALM data into the CRM data), depending on the source and destination. The configuration and mapping of data fields between the CRM platform and the ALM platform may be parameterized and customized by a user.

In various embodiments, ALM callout 270 may be configured to receive reformatted data from integration controller 240 and transmit the respective data to CRM database 115 and/or ALM database 125. In various embodiments, ALM callout 270 may also be configured to invoke ALM model 260 to reformat the data between the CRM platform and the ALM platform, prior to transmitting the respective data to CRM database 115 and/or ALM database 125.

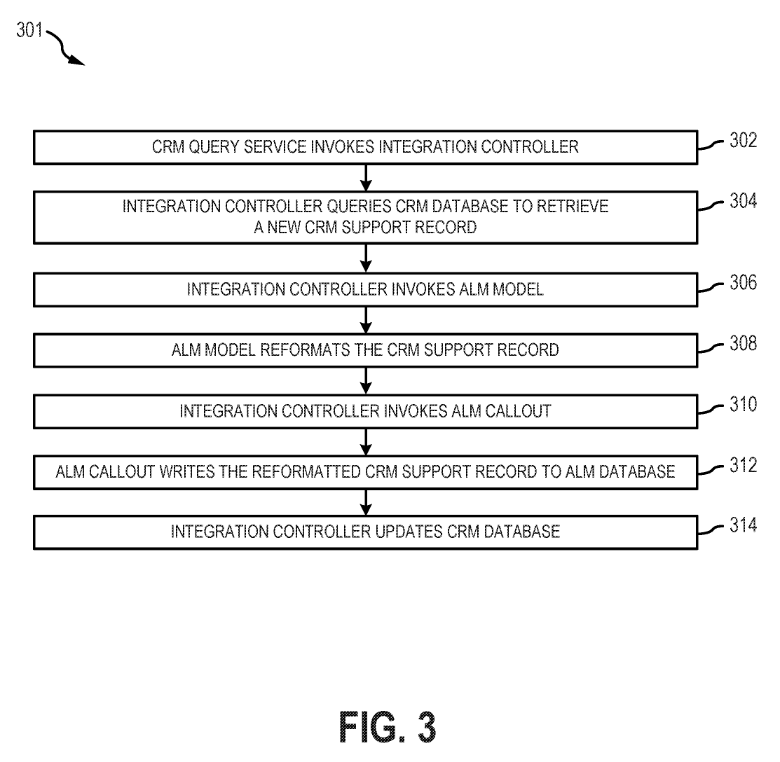

Referring now to FIGS. 3-7 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and elements depicted in FIGS. 3-7, but also to the various system components as described above with reference to FIGS. 1 and 2.

In various embodiments, and with specific reference to FIG. 3, a method 301 for executing a CRM query service 251 is disclosed. CRM query service 251 invokes integration controller 240 (step 302). CRM query service 251 may be configured to invoke integration controller 240 in response to CRM database 115 creating and storing a new CRM support record with a new CRM support record, or based on an integration interval. For example, a user may interact with CRM platform 101, via CRM platform interface 110, to input the CRM support record. The CRM support record may comprise data corresponding to a service request or the like, such as, for example, a name, a request date, a description, and the like. Integration controller 240 queries CRM database 115 to retrieve a new CRM support record (step 304). For example, integration controller 240 may store and track CRM support record IDs. In response to locating a CRM support record ID that was not previously stored and tracked, integration controller 240 may identify the CRM support record as being a new CRM support record. Integration controller 240 invokes ALM model 260 (step 306) by passing the new CRM support record.

In various embodiments, ALM model 260 reformats the CRM support record (step 308) using an ALM data format. For example, the ALM data format may comprise data indicating CRM data fields that correspond to ALM data fields. ALM model 260 may reformat the CRM support record by reformatting each of the CRM data fields in the CRM support record into one or more ALM data fields, according to the ALM data format. ALM model 260 may also be configured to convert the data into a format readable by and specified by the ALM platform, such as, for example, into a JavaScript Object Notation (JSON) format.

Integration controller 240 invokes ALM callout 270 (step 310) by passing the reformatted CRM support record. ALM callout 270 writes the reformatted CRM support record to ALM database 125 (step 312). ALM callout 270 may assign the reformatted CRM support record an ALM development request ID matching the CRM support record ID. In that respect, the original record and the reformatted record can later be matched in response to one of the records being updated. Integration controller 240 updates CRM database 115 (step 314). For example, integration controller 240 may update the CRM support record in CRM database 115 to indicate that the CRM support record was integrated into ALM platform 105, such as, for example, by adding the ALM development request ID to the database record.

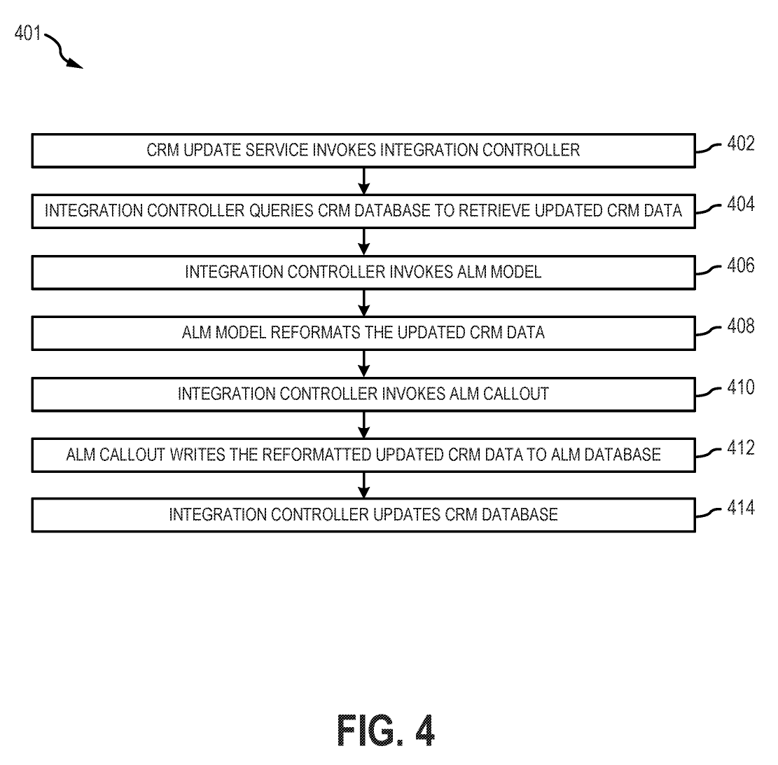

In various embodiments, and with specific reference to FIG. 4, a method 401 for executing a CRM update service 253 is disclosed. CRM update service 253 invokes integration controller 240 (step 402). CRM update service 253 may be configured to invoke integration controller 240 in response to CRM database 115 updating a CRM support record, or based on an integration interval. For example, CRM update service 253 may comprise a trigger that invokes integration controller 240 in response to data being created or updated in CRM platform 101. As an example, a user may interact with CRM platform 101, via CRM platform interface 110, to update the CRM support record (e.g., to add additional data, update a date or status, etc.). Integration controller 240 queries CRM database 115 to retrieve updated CRM data (step 404). The updated CRM data may correspond to the CRM support record and to a CRM support record ID. Integration controller 240 invokes ALM model 260 (step 406) by passing the updated CRM data. In various embodiments, ALM model 260 reformats the updated CRM data (step 408) using an ALM data format. For example, the ALM data format may comprise data indicating CRM data fields that correspond to ALM data fields. ALM model 260 may reformat the updated CRM data by reformatting each of the CRM data fields in the updated CRM data into one or more ALM data fields, according to the ALM data format. In various embodiments, there may be restrictions on data fields that cannot be reformatted (e.g., a “CRM number field” cannot be reformatted into an “ALM date field”), and that data field may not be reformatted and stored in the ALM database.

Integration controller 240 invokes ALM callout 270 (step 410) by passing the reformatted updated CRM data. ALM callout 270 writes the reformatted updated CRM data to ALM database 125 (step 412). For example, ALM callout 270 may query ALM database 125 to determine the ALM development request having an ALM development request ID matching the CRM support record ID. ALM callout 270 may write the reformatted updated CRM data to that ALM development request. Integration controller 240 updates CRM database 115 (step 414). For example, integration controller 240 may update the CRM support record in CRM database 115 to indicate that the updated CRM data was integrated into ALM platform 105.

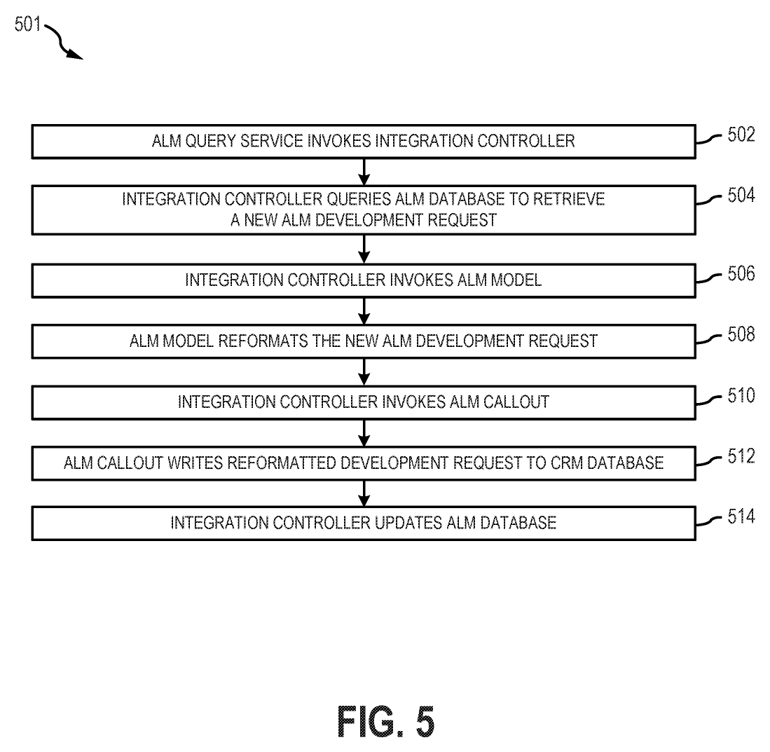

In various embodiments, and with specific reference to FIG. 5, a method 501 for executing an ALM query service 255 is disclosed. ALM query service 255 invokes integration controller 240 (step 502). ALM query service 255 may be configured to invoke integration controller 240 in response to ALM database 125 creating and storing a new ALM development request, or based on an integration interval. For example, a user may interact with ALM platform 105, via ALM platform interface 120, to input the ALM development request. The ALM development request may comprise data corresponding to a software development, such as, for example, a name, a Kanban state, a schedule state, an expected due date, a description, notes, acceptance criteria, and/or the like. Integration controller 240 queries ALM database 125 to retrieve the new ALM development request (step 504). For example, integration controller 240 may store and track ALM development request IDs. In response to locating an ALM development request that was not previously stored and tracked, integration controller 240 may identify the ALM development request as being a new ALM development request. Integration controller 240 invokes ALM model 260 (step 506) by passing the new ALM development request.

In various embodiments, ALM model 260 reformats the ALM development request (step 508) using a CRM data format. For example, the CRM data format may comprise data indicating ALM data fields that correspond to CRM data fields. ALM model 260 may reformat the ALM development request by reformatting each of the ALM data fields in the ALM development request into one or more CRM data fields, according to the CRM data format, and as discussed further herein.

Integration controller 240 invokes ALM callout 270 (step 510) by passing the reformatted ALM development request. ALM callout 270 writes the reformatted ALM development request to CRM database 115 (step 512). ALM callout 270 may assign the reformatted ALM development request a CRM support record ID matching the ALM development request ID. In that respect, the original record and the reformatted record can later be matched in response to one of the records being updated. Integration controller 240 updates ALM database 125 (step 514). For example, integration controller 240 may update the ALM development request in ALM database 125 to indicate that the ALM development request was integrated into CRM platform 101, such as, for example, by adding the CRM support record ID to the database record.

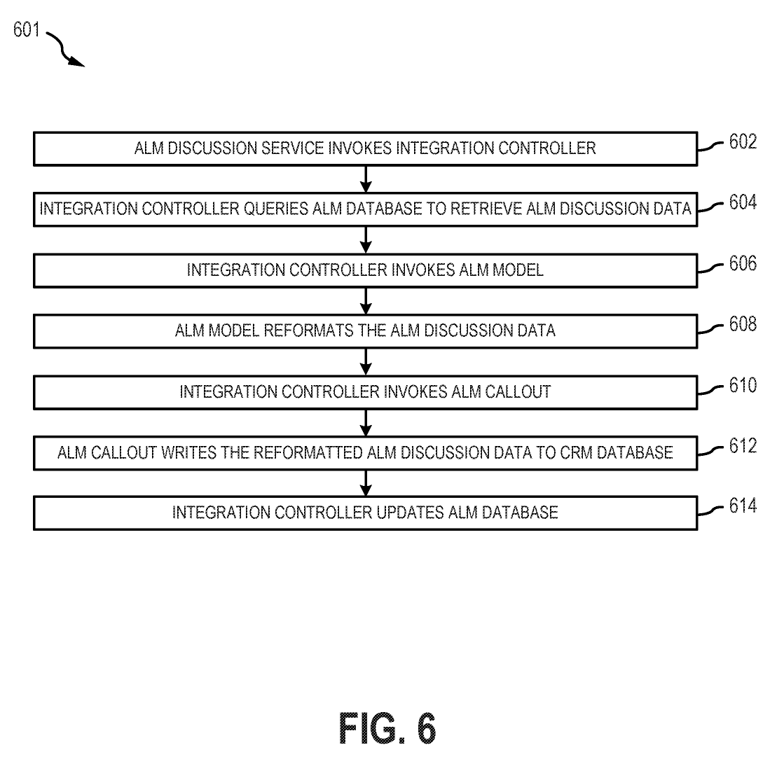

In various embodiments, and with specific reference to FIG. 6, a method 601 for executing an ALM discussion service 257 is disclosed. ALM discussion service 257 invokes integration controller 240 (step 602). ALM discussion service 257 may be configured to invoke integration controller 240 in response to ALM database 125 updating an ALM development request with additional data, such as discussion data. or based on an integration interval. For example, a user may interact with ALM platform 105, via ALM platform interface 120, to add discussion data to the ALM development request. Integration controller 240 queries ALM database 125 to retrieve the ALM discussion data (step 604). Integration controller 240 may be configured to query ALM database 125 at a defined interval to check for new or updated data. For example, and in accordance with various embodiments, the data may comprise a timestamp such that integration controller 240 may identify data as being new or updated based on the timestamp. The ALM discussion data may correspond to the ALM development request and to a ALM development request ID. Integration controller 240 invokes ALM model 260 (step 606) by passing the ALM discussion data. In various embodiments, ALM model 260 reformats the ALM discussion data (step 608) using a CRM data format. For example, the CRM data format may comprise data indicating ALM data fields that correspond to CRM data fields. ALM model 260 may reformat the ALM discussion data by reformatting each of the ALM data fields in the ALM discussion data into one or more CRM data fields, according to the CRM data format.

Integration controller 240 invokes ALM callout 270 (step 610) by passing the reformatted ALM discussion data. ALM callout 270 writes the reformatted ALM discussion data to CRM database 115 (step 612). For example, ALM callout 270 may query CRM database 115 to determine the CRM support record having a CRM support record ID matching the ALM development request ID. ALM callout 270 may write the reformatted ALM discussion data to that CRM support record. For example, the reformatted ALM discussion data may be stored as a child record to the CRM support record. Integration controller 240 updates ALM database 125 (step 614). For example, integration controller 240 may update the ALM development request in ALM database 125 to indicate that the ALM discussion data was integrated into CRM platform 101.

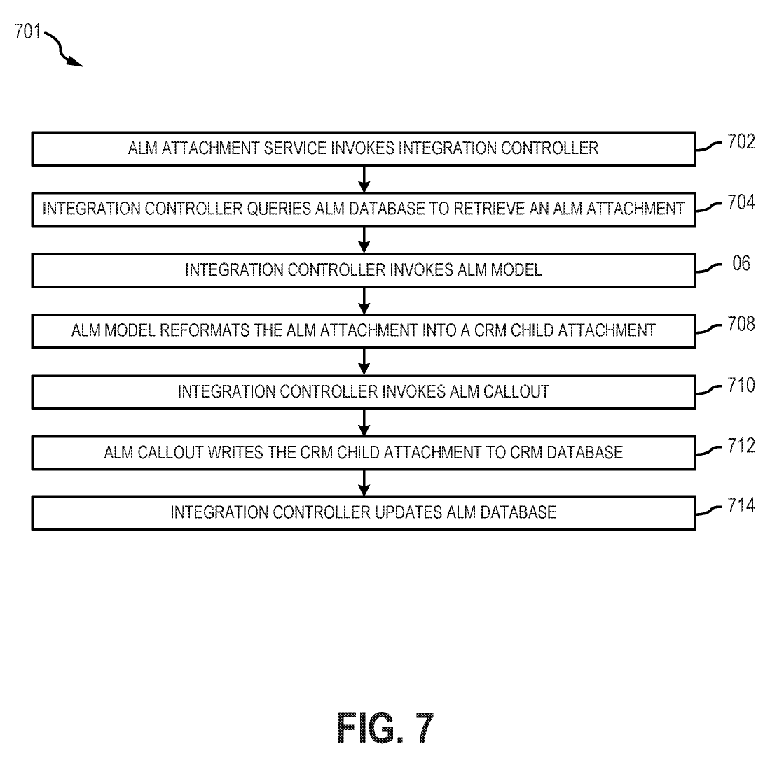

In various embodiments, and with specific reference to FIG. 7, a method 701 for executing an ALM attachment service 259 is disclosed. ALM attachment service 259 invokes integration controller 240 (step 702). ALM attachment service 259 may be configured to invoke integration controller 240 in response to ALM database 125 updating an ALM development request with additional data, such as an attachment, or based on an integration interval. For example, a user may interact with ALM platform 105, via ALM platform interface 120, to add an attachment to the ALM development request. The attachment may comprise a document (e.g., .doc, .xls, .pdf, etc.), an image (e.g., .jpg, .png, etc.), or the like corresponding to the ALM development request.

Integration controller 240 queries ALM database 125 to retrieve the ALM attachment (step 704). Integration controller 240 may be configured to query ALM database 125 at a defined interval to check for new attachments. For example, and in accordance with various embodiments, the attachments may comprise a timestamp such that integration controller 240 may identify attachments as being new or updated based on the timestamp. The ALM attachment may correspond to the ALM development request and to a ALM development request ID. Integration controller 240 invokes ALM model 260 (step 706) by passing the ALM attachment. In various embodiments, ALM model 260 reformats the ALM attachment into a CRM child attachment (step 708) using a CRM data format. For example, the CRM data format may comprise data indicating ALM data fields that correspond to CRM data fields. ALM model 260 may reformat the ALM attachment into the CRM child attachment by reformatting each of the ALM data fields in the ALM attachment into one or more CRM data fields, according to the CRM data format.

Integration controller 240 invokes ALM callout 270 (step 710) by passing the CRM child attachment. ALM callout 270 writes the CRM child attachment to CRM database 115 (step 712). For example, ALM callout 270 may query CRM database 115 to determine the CRM support record having a CRM support record ID matching the ALM development request ID. ALM callout 270 may write the CRM child attachment to that CRM support record. For example, the CRM child attachment may be stored as a child record to the CRM support record. Integration controller 240 updates ALM database 125 (step 714). For example, integration controller 240 may update the ALM development request in ALM database 125 to indicate that the ALM attachment was integrated into CRM platform 101.

The disclosure and claims do not describe only a particular outcome of integrating communications between a customer relationship (CRM) platform and an application lifecycle management (ALM) platform, but the disclosure and claims include specific rules for implementing the outcome of integrating communications between a CRM platform and an ALM platform and that render information into a specific format that is then used and applied to create the desired results of integrating communications between a CRM platform and an ALM platform, as set forth in McRO, Inc. v. Bandai Namco Games America Inc. (Fed. Cir. case number 15-1080, Sep. 13, 2016). In other words, the outcome of integrating communications between a CRM platform and an ALM platform can be performed by many different types of rules and combinations of rules, and this disclosure includes various embodiments with specific rules. While the absence of complete preemption may not guarantee that a claim is eligible, the disclosure does not sufficiently preempt the field of integrating communications between a CRM platform and an ALM platform at all. The disclosure acts to narrow, confine, and otherwise tie down the disclosure so as not to cover the general abstract idea of just integrating communications between a CRM platform and an ALM platform. Significantly, other systems and methods exist for integrating communications between a CRM platform and an ALM platform, so it would be inappropriate to assert that the claimed invention preempts the field or monopolizes the basic tools of integrating communications between a CRM platform and an ALM platform. In other words, the disclosure will not prevent others from integrating communications between a CRM platform and an ALM platform, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input, and/or any other method known in the art.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., FACEBOOK®, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, FACEBOOK® message, TWITTER® tweet and/or message, MMS, and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory or in-memory (non-spinning) hard drives. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components may include any suitable processor, or the like, such as application specific integrated circuits (ASICs). Implementation of the hardware machine so as to perform the functions described herein will be apparent to persons skilled in the relevant art(s).

In various embodiments, the server may include application servers (e.g. WEBSPHERE®, WEBLOGIC®, MOSS®, EDB® POSTGRES PLUS ADVANCED SERVER® (PPAS), etc.). In various embodiments, the server may include web servers (e.g. APACHE®, IIS, GWS, SUN JAVA® SYSTEM WEB SERVER, JAVA® Virtual Machine running on LINUX® or WINDOWS®).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, APPLE® IOS®, a BLACKBERRY® operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

Any databases discussed herein may include relational, hierarchical, graphical, blockchain, or object-oriented structure and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MySQL by MySQL AB (Uppsala, Sweden), MONGODB®, REDIS®, APACHE CASSANDRA®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a Hyperledger® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, and U.S. application Ser. No. 15/824,513 titled TRANSACTION AUTHORIZATION PROCESS USING BLOCKCHAIN and filed on Nov. 28, 2017, the contents of which are each incorporated by reference in its entirety.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set: e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPE”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as MICROSOFT® ACCESS® or MICROSOFT® SQL Server, ORACLE®, SYBASE®, INFORMIX® MySQL, INTERBASE®, etc., may be used to provide an Active Data Object (ADO) compliant database management system. In one embodiment, the Apache web server is used in conjunction with a Linux operating system, a MYSQL® database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT®, active server pages (ASP), common gateway interface scripts (CGI), extensible markup language (XML), dynamic HTML, cascading style sheets (CSS), AJAX (Asynchronous JAVASCRIPT® And XML), helper applications, plug-ins, and the like. A server may include a web service that receives a request from a web server, the request including a URL and an IP address (e.g., 192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE® MQTM (formerly MQSeries) by IBM®, Inc. (Armonk, N.Y.) is an example of a commercially available middleware product. An Enterprise Service Bus (“ESB”) application is another example of middleware.

Those skilled in the art will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript or the like. Cryptography and network security methods are well known in the art, and are covered in many standard texts.

In various embodiments, the software elements of the system may also be implemented using Node.js®. Node.js® may implement several modules to handle various core functionalities. For example, a package management module, such as Npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks (e.g., method 301, 401, 501, 601, 701, 801, with brief reference to FIGS. 3-8).

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is intended to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
retrieving, by an integration controller in electronic communication with a customer relationship management (CRM) platform, a CRM support record;
reformatting, by the integration controller in electronic communication with an application lifecycle management (ALM) model, the CRM support record into a ALM data format,
wherein the CRM support record is reformatted by converting CRM support record data fields into ALM development request data fields based on the ALM data format; and
transmitting, by the integration controller in electronic communication with an ALM platform, the reformatted CRM support record to the ALM platform.

2. The method of claim 1, wherein the integration controller is configured to retrieve the CRM support record in response to being invoked by a CRM query service.

3. The method of claim 1, wherein the CRM support record comprises a CRM support record ID and wherein the reformatted CRM support record comprises an ALM development request ID associated with the CRM support record ID.

4. The method of claim 3, further comprising:
retrieving, by the integration controller via the CRM platform, updated CRM data corresponding to the CRM support record ID;
reformatting, by the integration controller via the ALM model, the updated CRM data into a ALM data format,
wherein the updated CRM data is reformatted by converting updated CRM data fields into ALM development request data fields based on the ALM data format; and
transmitting, by the integration controller via the ALM platform, the reformatted updated CRM data to the ALM platform,

5. The method of claim 4, wherein the ALM platform is configured to store the reformatted updated CRM data with the reformatted CRM support record based on the ALM development request ID.

6. The method of claim 4, wherein the integration controller is configured to retrieve the updated CRM data in response to being invoked by a CRM update service.

7. The method of claim 1, wherein the CRM platform comprises a Salesforce CRM platform and the ALM platform comprises a Rally ALM platform.

8. A computer-based system comprising:
a processor,
a tangible, non-transitory memory configured to communicate with the processor, the tangible, non-transitory memory having instructions stored thereon that, in response to execution by the processor, cause the processor to perform operations comprising:
retrieving, by the processor in electronic communication with a customer relationship management (CRM) platform, a CRM support record;
reformatting, by the processor in electronic communication with an application lifecycle management (ALM) model, the CRM support record into a ALM data format,
wherein the CRM support record is reformatted by converting CRM support record data fields into ALM development request data fields based on the ALM data format; and
transmitting, by the processor in electronic communication with an ALM platform, the reformatted CRM support record for storage in the ALM platform.

9. The system of claim 8, wherein the processor is configured to retrieve the CRM support record in response to being invoked by a CRM query service.

10. The system of claim 8, wherein the CRM support record comprises a CRM support record ID and wherein the reformatted CRM support record comprises an ALM development request ID associated with the CRM support record ID.

11. The system of claim 10, further comprising:
retrieving, by the processor via the CRM platform, updated CRM data corresponding to the CRM support record ID;
reformatting, by the processor via the ALM model, the updated CRM data into a ALM data format,
wherein the updated CRM data is reformatted by converting updated CRM data fields into ALM development request data fields based on the ALM data format; and
transmitting, by the processor via the ALM platform, the reformatted updated CRM data to the ALM platform,

12. The system of claim 11, wherein the ALM platform is configured to store the reformatted updated CRM data with the reformatted CRM support record based on the ALM development request ID.

13. The system of claim 11, wherein the processor is configured to retrieve the updated CRM data in response to being invoked by a CRM update service.

14. A method, comprising:
retrieving, by an integration controller in electronic communication with an application lifecycle management (ALM) platform, an ALM development request;
reformatting, by the integration controller in electronic communication with an ALM model, the ALM development request into a customer relationship management (CRM) data format,
wherein the ALM development request is reformatted by converting ALM development request data fields into CRM support record data fields based on the CRM data format; and
transmitting, by the integration controller in electronic communication with a CRM platform, the reformatted ALM development request for storage in the CRM platform.

15. The method of claim 14, wherein the integration controller is configured to retrieve the ALM development request in response to being invoked by an ALM query service.

16. The method of claim 14, wherein the ALM development request comprises an ALM development request ID and wherein the reformatted ALM development request comprises a CRM support record ID associated with the ALM development request ID.

17. The method of claim 16, further comprising:
retrieving, by the integration controller via the ALM platform, ALM discussion data corresponding to the ALM development request;
reformatting, by the integration controller via the ALM model, the ALM discussion data into the CRM data format,
wherein the ALM discussion data is reformatted by converting ALM discussion data fields into CRM support record data fields based on the CRM data format; and
transmitting, by the integration controller via the CRM platform, the reformatted ALM discussion data for storage in the CRM platform associated with the development request ID of the ALM development request.

18. The method of claim 17, wherein the integration controller is configured to retrieve the ALM discussion data in response to being invoked by an ALM discussion service.

19. The method of claim 16, further comprising:
retrieving, by the integration controller via the ALM platform, an ALM attachment corresponding to the ALM development request;
reformatting, by the integration controller via the ALM model, the ALM attachment into a CRM child attachment,
wherein the ALM attachment is reformatted by converting ALM attachment data fields into CRM support record data fields based on the CRM data format; and
transmitting, by the integration controller via the CRM platform, the CRM child attachment for storage in the CRM platform associated with the development request ID of the ALM development request.

20. The method of claim 19, wherein the integration controller is configured to retrieve the ALM attachment in response to being invoked by an ALM attachment service.
